(19) United States
(12) Patent Application Publication
(10) Pub. No.: US 2025/0292239 A1
(43) Pub. Date: Sep. 18, 2025

(54) Method For The Activation, Securing, And Use Of Gift Cards Utilizing Authentication Methods Generated By Live Data In Real Time

(71) Applicant: International Marketing & Consulting, Inc., Sunrise, FL (US)

(72) Inventors: Michael Harris, London (GB); Ronald Prupis, Sunrise, FL (US)

(73) Assignee: International Marketing & Consulting, Inc., Sunrise, FL (US)

(21) Appl. No.: 19/078,122

(22) Filed: Mar. 12, 2025

Related U.S. Application Data
(60) Provisional application No. 63/564,196, filed on Mar. 12, 2024.

(51) Int. Cl. G06Q 20/38; G06Q 20/20; G06Q 20/40

(52) U.S. Cl. CPC G06Q 20/382; G06Q 20/209; G06Q 20/40

(57) ABSTRACT

A method of gift card security and authentication, having steps including the generation of an authentication passcode by utilizing data generated or obtained at the point of sale. Currently there is a problem in the industry of value on gift cards being stolen by individuals with prior access to hidden information on gift cards. This method prevents this type of fraud by requiring the generation or use of live data at the point of sale in order to monitor the value of a gift card. Because the data is obtained or generated at the point of sale, the fraudsters cannot perpetrate their scheme, as they cannot obtain the necessary information prior to the sale.

### CROSS-REFERENCE TO RELATED PATENT APPLICATIONS

The present application is a non-provisional application claiming priority to U.S. Provisional Patent Application Ser. No. 63/564,196, filed Mar. 12, 2024.

### BACKGROUND OF THE INVENTION

### 1. Field of the Invention

Embodiments of the invention relate generally to gift cards and more particularly to security features implemented in the process of purchasing gift cards to prevent and mitigate fraudulent activity.

### 2. Description of Related Art

Gift cards have become a multibillion-dollar industry and an integral part of gift-giving traditions. Gift cards typically are customized to a particular retailer, and usually cannot be used outside of that retailer, or a family of related retailers. Gift cards can either be bought in customizable or pre-determined amounts. Gift cards can be bought either directly from a retailer, either in-person or online, or it can be bought from another retailer. Typically, when a gift card is bought, either directly from a retailer or from an outside retailer, product identification information, such as may be stored on a barcode, is communicated to a central storage medium that stores activated cards. This product identification information may be stored with a dollar value, reflecting the value stored on the gift card. The starting value may be pre-determined or chosen by the customer at the time of purchase. Currently, once value is stored on the gift card, that value may be accessed, either for monitoring or use, by any individual or entity with access to the product identification information, either in the form of the physical gift card, or access to or knowledge of the product identification information.

A current issue in the gift card industry is fraudulent activity through the screening of store-available gift cards. In the current fraudulent scheme, individuals gain access to the normally hidden product identification information. This may happen through deconstruction and reconstruction of the product packaging, surreptitious observation of product identification information, or other methods of gaining access to the hidden information. The individuals gain the information for large numbers of gift cards available in physical stores, and then monitor the value of each gift card multiple times per day. Once value is added to any of the monitored gift cards by another consumer, the individuals engaging in the fraudulent activity utilize the product identification information to access and utilize the value added to the card before the intended recipient of the gift card can utilize it.

The inventive concept addresses this concern by adding authentication methods generated with live data obtained at the time of sale that cannot be bypassed by the above fraudulent methods. The authentication methods are generated at the time of purchase, which circumvents the above fraudulent methods by adding required information for authentication that cannot be pre-screened.

### SUMMARY OF THE INVENTION

The disclosed method adds security to the process of purchasing and activating a gift card at a point of sale. The method comprises generating authentication information to be tied to the product identification information utilizing live data at the point of sale. This authentication information can be generated at the point of sale in a number of ways, including, but not limited to, utilizing customer information such as a birthday or phone number, having the customer choose a numeric or alphanumeric passcode at the point of sale to be tied to the product identifying information, or utilizing a random number generating algorithm to provide live data that can be used to generate a passcode or other authentication method. The authentication information is then transmitted, along with the product identifying information, to a storage medium. The authentication information is also transmitted to the consumer, for use in monitoring or utilizing the gift card.

### BRIEF DESCRIPTION OF THE DRAWINGS

FIG. 1 is a diagram of the parts of a system that utilizes the method disclosed in this application.

FIG. 2 is a flowchart of the method disclosed in this application, along with markers for the tracking of various pieces of data through the method.

### DETAILED DESCRIPTION OF EMBODIMENTS

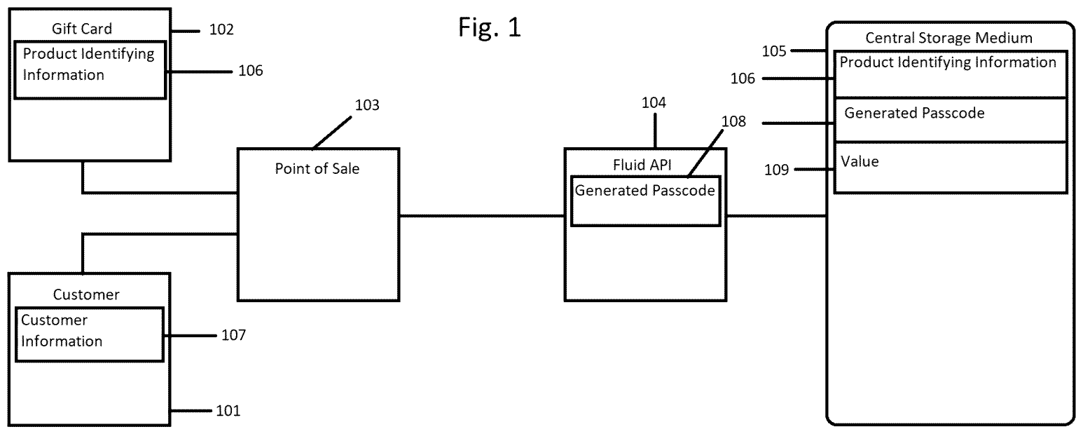

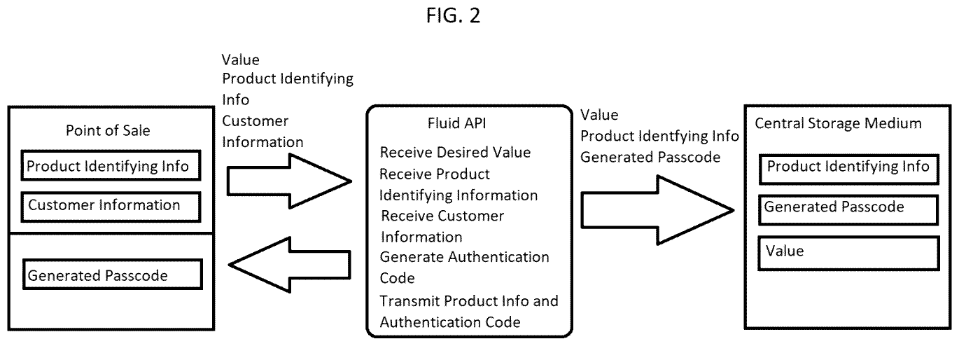

While the invention is illustrated and described in a preferred embodiment, the invention may be produced and described in many different configurations, forms, and various methods, without deviating from the scope of the present invention. The preferred embodiment of the invention is described in detail below with reference to the accompanying FIGS. 1-2, with the understanding that the present disclosure is to be considered as an exemplification of the principles of the invention and the associated functional specifications for its construction and is not intended to limit the invention to the embodiment illustrated. Those skilled in the art will envision many other possible variations within the scope of the invention described herein.

Referring now to FIGS. 1 and 2, a method is disclosed. The method is initiated when a customer 101 decides to purchase a gift card 102. The gift card has some product identifying information 106. This product identifying information 106 can take many forms, including, but not limited to, a barcode, a swipe strip, or a QR code, but all forms will constitute an identifier unique to that gift card 102 that may be utilized in a central storage medium 105 to associate the gift card 102 to the value 109 assigned to the gift card 102.

At the point of sale 103, value 109 for the gift card 102 is selected by the customer 101. The value 109 can either be pre-selected by the choice of a certain type of gift card, or it can be customized by the customer 101. Under the current system, the value 109 and the product identifying information 106 is then transmitted from the point of sale 103 to a central storage medium 105, which stores the product identifying information 106 for all activated gift cards 102, and the value associated with each gift card 102. Under the disclosed method, additional customer information 107 is obtained at the point of sale 103. This customer information 107 can take numerous forms, including, but not limited to, a customer phone number, a customer birth date, a number chosen by the customer, or customer address. The important common factors among all customer information 107 forms are that they are unique to the customer 101 and that they are obtained at the time of the sale of the gift card 102. The product identifying information 106, the value being added to the gift card 102, and the customer information 107 are encrypted and transmitted to the Fluid API 104, which interfaces between the point of sale 103 and the central storage medium 107. The Fluid API 104, having received the listed information, generates a passcode 108. The method that the Fluid API 104 uses to generate the passcode 108 may vary, including, but not limited to, a hashing algorithm, a hashing and salting algorithm, or random code generation utilizing the customer information 107 as a seed value. The generated passcode 108 may also be made utilizing other methods, such as random generation. While the methods that a passcode 108 may be generated are many, what is common amongst the forms is that the passcode 108 is generated at the time of sale utilizing either random number generation or live data. The product identifying information 106, the value 109 being assigned to that product, and the generated passcode 108 are then transmitted to the central storage medium 105 for storage and indexing of activated gift cards. This central storage medium 105 may take a variety of forms, including, but not limited to, a server, a database, or a blockchain. The form of the central storage medium 105 may vary, but all forms store product identifying information 106 and the value assigned to the gift card 102 associated with that product identifying information 106. The generated passcode 108 is transmitted back to the point of sale 103 for communication to the customer. This passcode 108 may be communicated in any number of ways, including, but not limited to, on a receipt, digitally, or via any number of other communications that occur at the point of sale 103.

A common feature of the gift card industry is the ability to check the value 109 of a gift card 102 on a website. Currently, all that is required to check the balance of value 109 on a gift card 102 is the product identifying information 106. An individual with the product identifying information 106 may input that information to the website and receive the current value 109 on the gift card 102. The above-described fraud relies on non-customer individuals who have the product identifying information 106 checking the balance on a gift card 102 to determine if the customer 101 has added value 102 to the card, and then using that value 102 before the customer 101. Under the disclosed system, an individual wanted to check the balance of the value 102 on the gift card 102 will require at least the generated passcode 108. In other embodiments of the system, an individual will require both the product identifying information 106 and the generated passcode 108. In another embodiment of the invention, the value 109 on the gift card 102 may be checked utilizing the customer information 107. In all embodiments of the invention, use of the live data or the generated code 108 is necessary to check the balance on the gift card 102. In the above-described fraud, the individuals committing the fraud obtain large amounts of product identifying information 106 prior to the sale of those products. The individuals then monitor the value 109 on those gift cards 102 through the use of that product identifying information 106. By requiring the use of the generated passcode 108, the individuals will be unable to monitor the value on the gift cards 102, as it requires information that is only generated at the time of sale-after the individuals have gathered information. To perpetrate their scheme, the individuals would need access to generated passcode 108, or the live data utilized to generate it and the algorithm used to generate it. This method places substantial obstacles in the way of the individuals and would prevent the fraudulent scheme outlined above. In this way, the customer 101 can be assured that the value 102 that they place on the gift card 102 will be safe and free from theft through the outlined scheme.

In another embodiment of the invention, the customer 101 may query the system for the passcode 108 by entering the utilized customer information 107. This embodiment still protects from the described fraud, as it utilizes the same data that would have been generated or used live at the time of sale, which the individuals engaging in fraud would not have access to.

In another embodiment of the invention, the customer information 107 is required to be the customer's 101 telephone number. The Fluid API 104 then communicates the generated passcode 108 to the customer's 101 phone directly, rather than through the point of sale 103.

In another embodiment of the invention, the generated passcode 108 is communicated by altering the gift card 102 at the point of sale 103 to display the generated passcode 108. This alteration can be performed in a variety of ways, including, but not limited to, printing the generated passcode 108 on the gift card 102, embossing the generated passcode 108 on the gift card 102, and etching the generated passcode 108 on the gift card 102.

In another embodiment of the invention, the generated passcode 108 is required for both checking the balance of the gift card 102 and for redeeming any value of the gift card 102, rather than just for checking the balance of the gift card 102.

The principles, embodiments, and modes of operation of the present invention have been set forth in the foregoing specification. The embodiments disclosed herein should be interpreted as illustrating the present invention and not as restricting it. The foregoing disclosure is not intended to limit the range of equivalent structure available to a person of ordinary skill in the art in any way, but rather to expand the range of equivalent structures in ways not previously contemplated. Numerous variations and changes can be made to the foregoing illustrative embodiments without departing from the scope and spirit of the present invention.

The above description of the disclosed embodiments is provided to enable any person skilled in the art to make or use the invention. Various modifications to these embodiments will be readily apparent to those skilled in the art, and the generic principles described herein can be applied to other embodiments without departing from the spirit or scope of the invention. Thus, it is to be understood that the description and drawings presented herein represent particular aspects and embodiments of the invention and are therefore representative examples of the subject matter that is broadly contemplated by the present invention. It is further understood that the scope of the present invention fully encompasses other embodiments that are, or may become, obvious to those skilled in the art and that the scope of the present invention is accordingly not limited by the descriptions presented herein.

I claim:

1. A method for the activation of a gift card, the steps consisting of:
obtaining product identifying information and added value from a customer at a point of sale;
encrypting the product identifying information and added value;
transmitting the product identifying information and added value from the point of sale to the Fluid API;
generating a passcode;
transmitting the product identifying information, added value, and passcode to a central storage method for indexing;
communicating the passcode to the customer; and
requiring the customer to utilize the passcode to check the value of the gift card.

2. The method of claim 1, wherein customer information is obtained at the point of sale from the customer.

3. The method of claim 2, wherein the customer information is utilized in generating the passcode.

4. The method of claim 1, wherein the passcode is communicated to the customer by transmitting the passcode to the point of sale and the passcode is provided to the customer on a receipt.

5. The method of claim 1, wherein the passcode is communicated to the customer by transmitting the passcode to the point of sale and the passcode is provided to the customer digitally.

6. The method of claim 1, wherein the passcode is communicated to the customer by sending the code via text to a provided phone number.

7. The method of claim 1, wherein the passcode is communicated to the customer by altering the gift card at the point of sale to display the generated passcode.

8. The method of claim 1, wherein the passcode is generated by requesting a code from the customer and using that code as the passcode.

9. The method of claim 1, further consisting of the step of:
requiring the customer to utilize the passcode to redeem any value of the gift card.

10. The method of claim 1, wherein the central storage method is a database.

11. The method of claim 1, wherein the central storage method is a blockchain.
